(19) United States
(12) Patent Application Publication
(10) Pub. No.: US 2024/0062278 A1
(43) Pub. Date: Feb. 22, 2024

(54) PROCESSING DEVICE, PROCESSING METHOD, AND PROCESSING PROGRAM

(71) Applicant: NTT QONOQ, INC., Chiyoda-ku (JP)

(72) Inventors: Toshimitsu NAKAMURA, Chiyoda-ku (JP); Misa YAMAZAKI, Chiyoda-ku (JP); Sachiyo KAWAHARA, Chiyoda-ku (JP)

(73) Assignee: NTT QONOQ, INC., Chiyoda-ku (JP)

(21) Appl. No.: 18/262,364

(22) PCT Filed: Jan. 21, 2022
(86) PCT No.: PCT/JP2022/002217

§ 371 Date: Jul. 20, 2023

(30) Foreign Application Priority Data
Jan. 22, 2021 (JP) 2021-009102

(51) Int. Cl. G06Q 30/0601; G06T 19/20; H04L 51/046

(52) U.S. Cl. CPC G06Q 30/0643; G06T 19/20; H04L 51/046; G06T 2219/024; G06T 2219/2004

(57) ABSTRACT

A server apparatus (10) includes: a building unit (132) configured to build a virtual shop at which viewing and purchase of a product can be performed by a user in a virtual space and provide the virtual shop for a user terminal used by the user; a sharing setting unit (133) configured to provide, when entry of a plurality of users having a relationship into the virtual shop is registered, a chatting environment that can be shared among the plurality of users for the user terminal used by each of the plurality of users; and a sharing unit (134) configured to perform control such that a function of the virtual space is shared among the plurality of users on the basis of a comment of a chatting.

### TECHNICAL FIELD

The present invention relates to a processing device, a processing method, and a processing program.

### BACKGROUND ART

Conventionally, purchase of products using web sites (Electronic Commerce (EC) sites) selling products on the Internet is generally available. In addition, in recent years, technologies of providing purchase experiences of the same degree as that of purchase of products at an actual shop for users by reproducing a shop in a virtual space and linking the shop with an EC site have been proposed.

### CITATION LIST

### Patent Literature

Patent Literature 1: Japanese Unexamined Patent Publication No. 2004-220074

### SUMMARY OF INVENTION

### Technical Problem

Although shopping at an actual shop is often done together with friends and family members, it is difficult to shop together with friends and family members at a virtual shop reproduced in a virtual space in contrast to an actual shop.

The present invention is in view of the description presented above, and an object thereof is to provide a processing device, a processing method, and a processing program through which a shopping environment can be easily shared with other users at a virtual shop reproduced in a virtual space.

### Solution to Problem

In order to achieve the object by solving the problems described above, a processing device according to the present invention includes: a building unit configured to build a virtual shop at which viewing and purchase of a product can be performed by a user in a virtual space and provide the virtual shop for a user terminal used by the user; a provision unit configured to provide, when entry of a plurality of users having a relationship into the virtual shop is registered, a chatting environment that can be shared among the plurality of users for the user terminal used by each of the plurality of users; and a sharing unit configured to perform control such that a function of the virtual space is shared among the plurality of users on the basis of a comment of a chatting.

### Advantageous Effects of Invention

According to the present invention, a shopping environment can be shared, with other users at a virtual shop reproduced in a virtual space.

### BRIEF DESCRIPTION OF DRAWINGS

FIG. 1 is a block diagram illustrating an example of the configuration of a communication system according to an embodiment.

FIG. 2 is a block diagram illustrating an example of the configuration of a server apparatus illustrated in FIG. 1.

FIG. 3 is a diagram illustrating an example of sharing of a function of a virtual space between users using chatting.

FIG. 4 is a diagram illustrating an example of sharing of a function of a virtual space between users using chatting.

FIG. 5 is a diagram illustrating an example of sharing of a function of a virtual space between users using chatting.

FIG. 6 is a sequence diagram illustrating a processing sequence of a communication process in a communication system according to an embodiment.

FIG. 7 is a diagram illustrating a computer executing a program.

### DESCRIPTION OF EMBODIMENTS

Hereinafter, a processing device, a processing method, and a processing program according to an embodiment of the present application will be described in detail with reference to the drawings. A processing device, a processing method, and a processing program according to the present application are not limited to this embodiment.

In the following embodiment, the processing flow of a processing device, a processing method, and a processing program according to the embodiment will be described in order, and finally effects according to the embodiment will be described.

### Embodiment

First, an embodiment will be described. In the embodiment, a communication system used for providing a shopping environment in a virtual space for a user will be described.

In the communication system according to the embodiment, in a server apparatus of a virtual reality (VR) store provider side providing a shopping environment for a user, a VR store is built in a virtual space, and products are disposed inside the VR store such that they can be viewed and purchased. Then, in a server apparatus of a VR store provider side, by providing a chatting environment that can be shared among a plurality of users having a relationship of friends, family members, and the like and enabling a function in a virtual space to be shared among a plurality of users through chatting comments, shopping together with friends and family members is enabled also in the virtual space like at an actual shop.

[Configuration of Communication System]

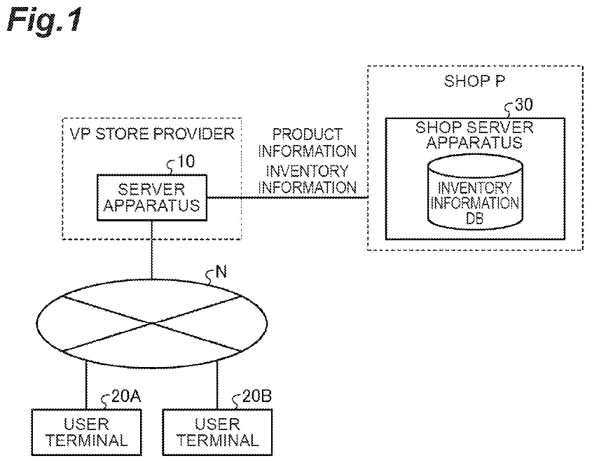

The configuration of a communication system according to an embodiment will be described. FIG. 1 is a block diagram illustrating an example of the configuration of the communication system according to the embodiment.

As illustrated in FIG. 1, the communication system according to the embodiment includes user terminals 20A and 20B used by respective users and a server apparatus 10 (a processing apparatus) of a VR store provider. The server apparatus 10 is connected to a shop server apparatus 30 of a shop P that sells products. In addition, the configuration illustrated in FIG. 1 is merely one example, and a specific configuration and the number of respective devices are not particularly limited.

The server apparatus 10 (the processing apparatus) of the VR store provider receives information of products that can be exhibited in a VR store or an advertisement from a shop server apparatus 30 of a shop P selling products and provides a VR store in which such products are displayed for users. In the VR store, by selecting a product, a user can refer to product information such as a type, a color, a size, a price, and the like of the product, and by performing a predetermined process, the process can proceed up to a purchase process of the product. In addition, the server apparatus 10 can reproduce a virtual street in a virtual space, build a virtual shopping mall in which a plurality of VR stores and street advertisements are disposed on the street (a VR shopping mall), and provide the virtual shopping mall for users.

The shop server apparatus 30 has an inventory DB of maintained products. The shop server apparatus 30 transmits information of products that can be exhibited in a VR store and advertisements among maintained products to the server apparatus 10 through a network or the like. The shop server apparatus 30 transmits identification information, a name, a size, a color, a price, inventory information, and the like of products as information of the products.

The user terminals 20A and 20B are information processing devices such as notebook personal computers (PC), desktop PCs, or the like or smart devices such as a tablet, a smartphone, and the like. The user terminals 20A and 20B are connected to the server apparatus 10 through a network N and are provided with a VR store. The user terminals 20A and 20B perform viewing of products and advertisements and purchase of products inside the provided VR store.

The user terminal 20A is a terminal that is used by a user A, and the user terminal 20B is a terminal that is used by a user B. In this embodiment, as an example, it is assumed that the user A and the user B have a relationship of family members, friends, or the like and shop together inside a VR store. In addition, the number of users having a relationship is not limited to two and may be three or more.

In the server apparatus 10, when the user A and the user B enter a VR store such that the user A and the user B can shop together inside the VR store, on a screen of the inside of the VR store of each of the user terminal 20A and the user terminal 20B, avatars of the users A and B are displayed. Then, the server apparatus 10 provides a chatting environment that can be shared between the users A and B and enables the users A and B to communicate with each other. In addition, by enabling a function in a virtual space (for example, position or product information) to be shared between the users A and B through chatting comments, the server apparatus 10 realizes a shopping experience between friends and family members with the same degree as at an actual shop also in the virtual space. Next, the server apparatus 10 illustrated in FIG. 1 will be described.

[Server Apparatus]

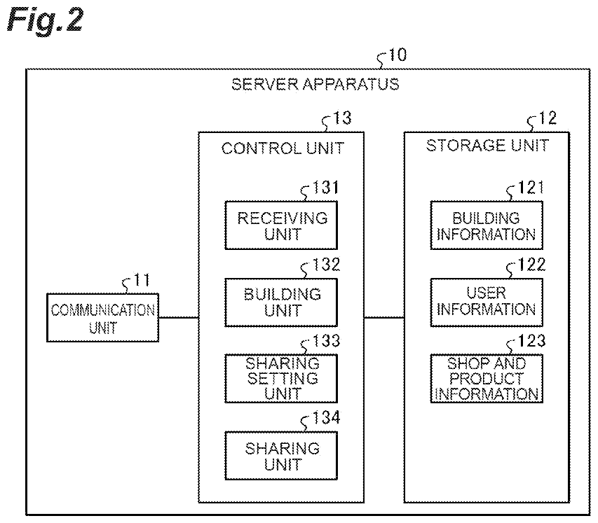

FIG. 2 is a block diagram illustrating an example of the configuration of the server apparatus 10 illustrated in FIG. 1. As illustrated in FIG. 2, this server apparatus 10 includes a communication unit 11 that controls communication related to various kinds of information, a storage unit 12 that stores data and programs required for various processes performed by a control unit 13, and the control unit 13 that performs various processes. Hereinafter, the process of each unit included in the server apparatus 10 will be described.

The communication unit 11 is a communication interface that transmits/receives various kinds of information to/from other devices connected through a network or the like. The communication unit 11 is realized using a network interface card (NIC) or the like and performs communication between another device connected through a telecommunication line such as a local area network (LAN), the Internet, or the like and the control unit 13 (to be described below). For example, the communication unit 11 receives information of products that can be exhibited from the shop server apparatus 30 through a network. In addition, the communication unit 11 receives a request for entry into the VR store, a request for sharing between the users A and B, or a viewing request or a purchase request for a product from the user terminals 20A and 20B through a network N. The communication unit 11 transmits a purchase procedure of a product and information about an inventory update after the product purchase to the shop server apparatus 30.

The storage unit 12 is a storage device such as a hard disk drive (HDD), a solid-state drive (SSD), or the like. In addition, the storage unit 12 may be a data-rewritable semiconductor memory such as a random access memory (RAM), a flash memory, a non-volatile static random access memory (NVSRAM), or the like. The storage unit 12 stores an operating system (OS) and various programs executed by the server apparatus 10. In addition, the storage unit 12 stores various kinds of information used for execution of programs. The storage unit 12 stores building information 121, user information 122, and shop and product information 123.

The building information 121 is information that is necessary for building a VR store and a VR shopping mall in a virtual space. The building information 121 includes image processing conditions and an image processing program used for building a VR store and a VR shopping mall in a virtual space. In addition, for example, in a case in which a VR store and a VR shopping mall are built using Photo VR or Planet enabling a panoramic view of products in a space inside a 360° sphere, the building information 121 may include photographs acquired by capturing an in-shop view, products, a street landscape, and an external shop view with a fixed point or 360° or images of the VR store and the VR shopping mall built by performing image processing of such photographs. For example, in a case in which a VR store and a VR shopping mall are built using computer graphics (CG), the building information 121 represents images reproducing an in-shop view, products, a street landscape, and an external shop view.

The user information 122 is information about each user registered in a VR store and a VR shopping mall as a customer. For example, the user information 122 includes an ID of each user and a purchase history and a viewing history associated with each user ID. For example, the purchase history has a purchase time, a name of a shop at which a product has been purchased, a product ID, a product name, a size, a color, and a quantity as items. For example, the viewing history has a viewing time, a name of a shop at which a product has been viewed, a product ID, a product name, a size, a color, and a quantity as items.

The shop and product information 123 is information about a shop disposed in a VR shopping mall and products exhibited inside a VR store. The shop and product information 123 has a store ID, a shop type, and a product ID, a product name, a size, a color, and a quantity of each of products that can be exhibited in a VR store or an advertisement among products maintained by each shop as items. For example, a shop P is a grocery store, and cutlery and cups are represented as products that can be exhibited together with features such as sizes, colors, and the like of such products and the quantity of inventories.

The control unit 13 controls the whole server apparatus 10. For example, the control unit 13 is an electronic circuit such as a central processing unit (CPU) or a micro processing unit (MPU) or an integrated circuit such as an application specific integrated circuit (ASIC) or a field programmable gate array (FPGA). In addition, the control unit 13 includes an internal memory for storing a program defining various processing sequences and control data and performs each process using the internal memory. Furthermore, in accordance with operations of various programs, the control unit 13 functions as various processing units. The control unit 13 includes a reception unit 131, a building unit 132, a sharing setting unit 133 (provision unit), and a sharing unit 134.

The reception unit 131 accepts entrance into a VR shopping mall, entry into a VR store inside the VR shopping mall, viewing of a product, purchase of a product, and a request for sharing between the users A and B from a user.

The building unit 132 builds a VR store and a VR shopping mall in a virtual space using photo VR, Planet, or CG. When entry into a VR store is accepted from a user, the building unit 132 builds the VR store in the virtual space. Then, the building unit 132 provides the built VR store for the user terminal 20 used by the user.

In the VR store, an inner view is built on the basis of an actual shop, and products that can be exhibited among products maintained by the actual shop are displayed such that they are exhibited using an exhibition method of the inside of the actual shop (arrangement in one row in a display rack or the like). For each of the exhibited products, product information (a type, a color, a shape, a size, a price, and an inventory status) is provided to be able to be viewed. The exhibited products can be purchased as well. In addition, in the VR store, in an arbitrary area inside the shop, an advertisement of products and the like exhibited in the shop can be displayed as well. In the VR store, a user can move an avatar of the user such that it walks inside the actual shop.

Then, when entrance of a user into a VR shopping mall is received, the building unit 132 may acquire the building information 121 and build the VR shopping mall in a virtual space. In the VR shopping mall, on the basis of an actual street landscape, arrangement of each shop, an external view of each shop, roads, and corresponding advertisements are built. In the VR shopping mall, a user can move an avatar of the user such that the avatar walks on the actual street landscape. Then, in the VR shopping mall, for example, by clicking or tapping on a shop name or an entrance of a shop displayed in a shop external view, a user can enter the selected VR store.

In addition, when an entrance of a user into a VR shopping mall is received, the building unit 132 may also build each VR store disposed in the VR shopping mall together with the VR shopping mall. Furthermore, the building unit 132, for each season, may change a landscape of a street of the VR shopping mall, products exhibited in a VR store, and products displayed in advertisements.

When entry into the VR store is received from the users A and B having a relationship, the sharing setting unit 133 causes avatars of the users A and B to be displayed in the user terminals 20A and 20B on the basis of a sharing request from the users A and B and sharing permission. In accordance with this, the users A and B can share positions of the users A and B inside the VR store. The sharing setting unit 133 provides a chatting environment that can be shared between the users A and B for user terminals 10A and 20B respectively used by the users A and B. In accordance with this, the users A and B can take communication through chatting. In addition, the sharing setting unit 133 may provide a chatting environment that can be shared between the users A and B for the user terminals 10A and 20B also in the VR shopping mall.

The sharing unit 134 performs control such that a function of a virtual space is shared between the users A and B on the basis of a chatting comment.

For example, the sharing unit 134 causes positions to be shared between the users A and B by moving one person out of the users A and B to the position of the other user in a virtual space. In addition, the sharing unit 134 causes information relating to a product viewed by one person out of the users A and B to be shared between the users A and B in the virtual space. For example, the information relating to a product is a type, a shape, a color, a size, and a price of the product. In addition, the information relating to a product is an image in which this product (for example, furniture) is installed inside a house. Furthermore, the information relating to a product is a try-on image of this product (for example, clothes). In addition, the information relating to a product is a chatting screen or a video call screen with an on-site staff of a shop selling this product.

The sharing unit 134 estimates whether or not there is intention of a user who has written a comment for sharing a function of a virtual space with other users in details of the chatting comment.

For example, by referring to a table in which a plurality of comments written at the time of sharing a function with other users are stored in association with sharing details, the sharing unit 134 estimates whether or not there is intention of a user who has written a comment for sharing a function of a virtual space with the other users. In addition, for example, by using a model, the sharing unit 134 may estimate whether or not there is intention of a user who has written a comment for sharing a function of a virtual space with other users. The model learns whether or not there is intention for sharing a function of a virtual space with other users in a comment by using data in which presence/absence of intention for sharing a function of a virtual space with other users is assigned to a chatting comment for each comment as learning data.

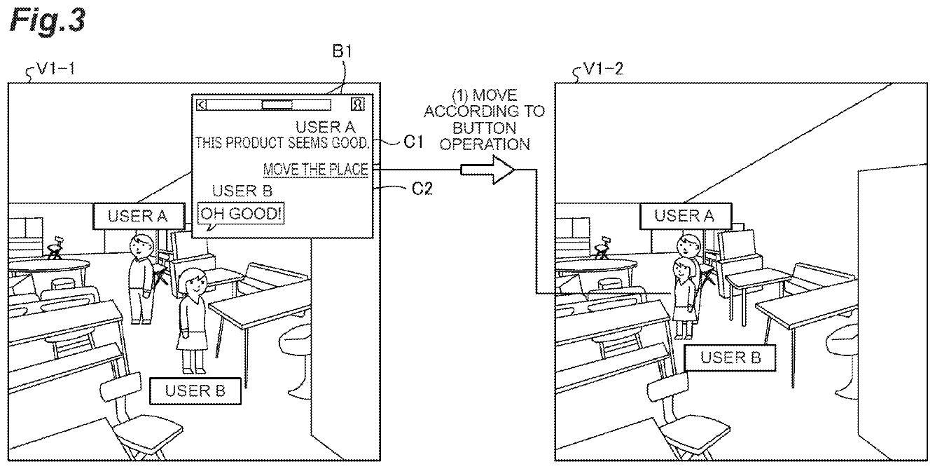

Then, in a case in which it is estimated that a user who has written a comment has intention for sharing a function of a virtual space with other users, the sharing unit 134 performs control such that the function of the virtual space is shared among a plurality of users. In a case in which it is estimated that the user who has written the comment has intention for sharing the function of the virtual space with other users, when a comment inquiring about sharing/non-sharing is represented in a chatting environment, and the sharing is permitted, the sharing unit 134 performs control such that the function of the virtual space is shared between the users A and B. Hereinafter, an example of sharing of a function of a virtual space between users A and B will be described with reference to FIGS. 3 to 5.

[Example of Sharing of Function of Virtual Space]

First, an example of sharing of a function of a virtual space between users A and B will be described with reference to FIGS. 3 to 5. FIGS. 3 to 5 are diagrams illustrating an example of sharing of a function of a virtual space between users A and B using chatting.

In FIG. 3, a position moving function through chatting will be described. As illustrated in a screen V1-1 in FIG. 3, the building unit 132 provides a screen in which a shop inner view in which a plurality of products are aligned is reproduced in a virtual space for a user as a VR store. Here, in a case in which sharing of a shopping environment of the VR store is requested from users A and B, as illustrated in FIG. 3, the sharing setting unit 133 displays avatars of the users A and B inside the VR store such that positions of the users A and B can be known in any screen of user terminals 20A and 20B respectively used by the users A and B.

Then, the sharing setting unit 133 displays a chatting box B1 that can be used between the users A and B and enables communication between the users A and B. For example, in a case in which a comment C1 “This product seems good!” is written in this chatting box B1 from the user A, the sharing unit 143 estimates that there is intention for sharing information of this product with the user B. Then, the sharing unit 134 displays a button C2 enabling selection of “moving the place” of the user B to a place at which the user A is present for sharing information of the product in the chatting box B1.

When the user B presses the button C2, as illustrated in a screen V1-2 of FIG. 3, the sharing unit 134 moves the position of the user B to the place at which the user A is present. By only performing a button operation, the user B can move to the position of the user A (see (1) of FIG. 3). Then, the user B can view the product being viewed by the user A altogether. At this time, the user B can share a product information screen of a product being viewed by the user A as well. In this way, in the embodiment, by only pressing a movement button that is automatically displayed in response to chatting such as “This product seems good!”, the other user B can move to the place of one user A.

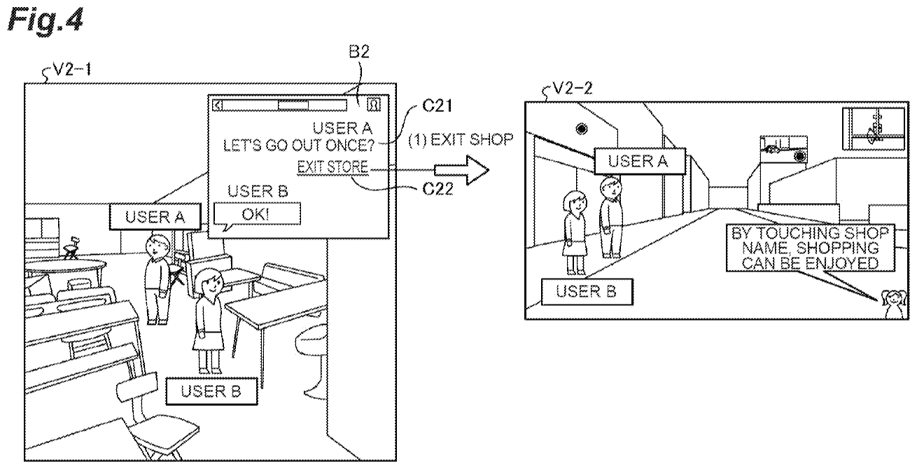

Referring to FIG. 4, an automatic shop exiting function through chatting will be described. As illustrated in a screen V2-1 of FIG. 4, for example, in a case in which a comment C21 “Let's go out once?” is written in this chatting box B2 from the user A, the sharing unit 143 estimates that there is intention of the user A for exiting the currently-positioned VR store. Then, in order to share a shop exiting operation, the sharing unit 134 displays a button C22 enabling the user B to select “Exiting the shop” in the chatting box B2.

When the user B presses the button C22, as illustrated in a screen V2-2 of FIG. 4, the sharing unit 134 causes the user B to exit the shop together with the user A (see (1) of FIG. 4). In this way, in the embodiment, by only pressing a button for exiting the shop that is automatically display in response to chatting “Let's go out” or the like, the users A and B can exit the shop altogether. In this way, by estimating an intention for exiting the VR store in the chatting, the server apparatus 10 can easily perform a shop exiting action.

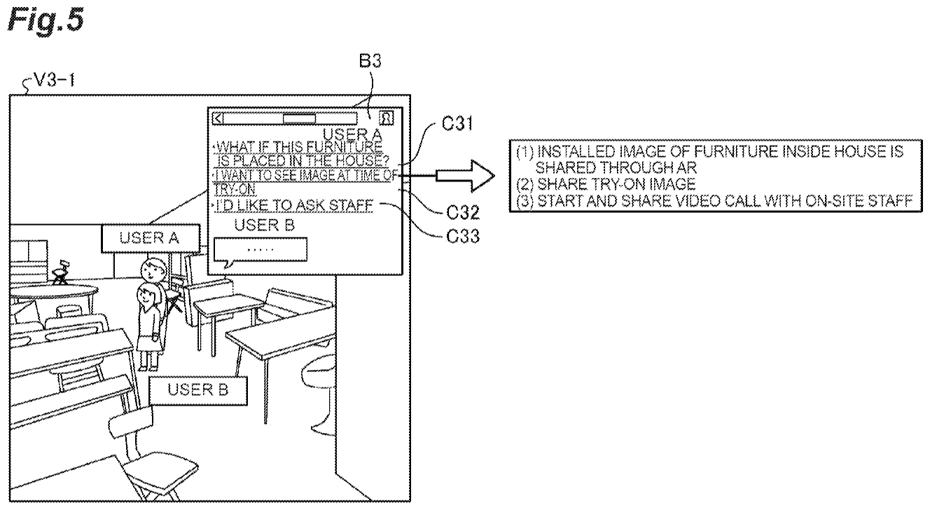

In addition, functions of various virtual spaces can be shared in a simple manner through chatting. For example, as illustrated in a screen V3-4 of FIG. 5, a case in which a comment C31 “What if this furniture is placed in the house?” is written into the chatting box B3 by the user A will be described. In this case, the sharing unit 134 estimates that there is intention of the user A for sharing an image of installed furniture inside the house with the user B. Then, the sharing unit 134 performs control such that the image of the installed furniture inside the house can be shared using augmented reality (AR) inside the screens of the user terminals 20A and 20B (see (1) of FIG. 5).

In addition, a case in which a comment C32 “I want to see an image at the time of try-on” is written into the chatting box B3 by the user A will be described. In this case, the sharing unit 134 estimates that the user A has intention for sharing a try-on image of the product with the user B. Then, the sharing unit 134 performs control such that the try-on image of the product of the user A can be shared inside the screens of the user terminals 20A and 20B (see (2) of FIG. 5).

In addition, a case in which a comment C33 “I'd like to ask a staff” is written into the chatting box B3 by the user A will be described. In this case, the sharing unit 134 estimates that the user A has intention for sharing an inquiry for an on-site staff of a shop selling this product and a reply thereof with the user B. Then, the sharing unit 134 performs control such that a chatting screen or a video call screen with an on-site staff of a shop selling this product is started inside the screens of the user terminals 20A and 20B, and the screens can be shared (see (3) of FIG. 5).

In this way, in this embodiment, various functions of a virtual space can be easily shared between the users A and B through chatting, and thus, also in the virtual space, a shopping experience among a plurality of persons that is of the same degree as that of an actual shop can be realized in a simple manner.

[Processing Sequence of Communication Process]

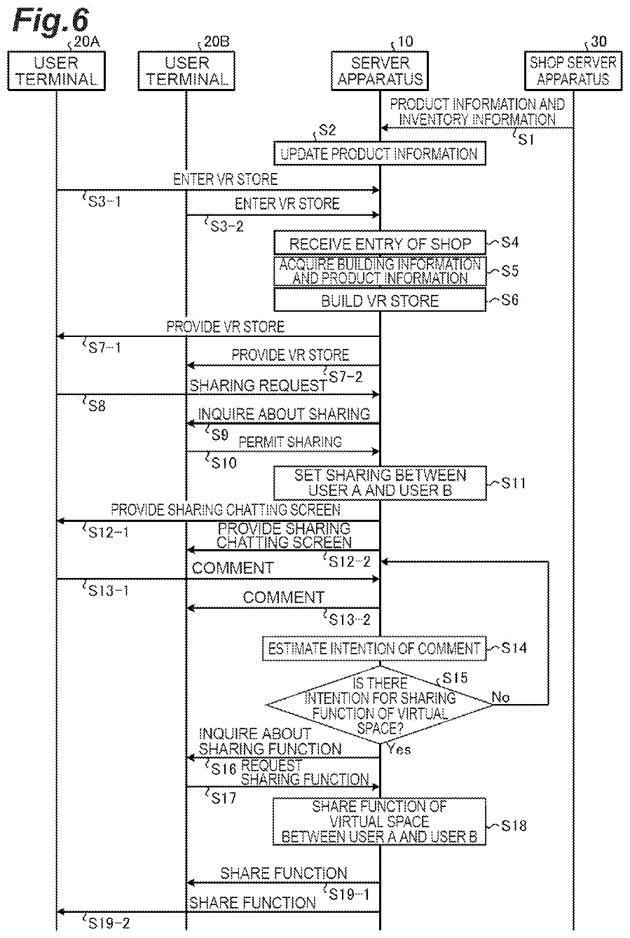

FIG. 6 is a sequence diagram illustrating a processing sequence of a communication process in a communication system according to an embodiment.

As illustrated in FIG. 6, when product information and inventory information are received from the shop server apparatus 30 (Step S1), the server apparatus 10 updates the shop and product information 123 (Step S2).

In the server apparatus 10, when the reception unit 131 receives a shop opening application for a VR store from the user terminals 20A and 20B (Steps S3-1, S3-2, and S4), the building unit 132 acquires the building information 121 and the shop and product information 123 (Step S5) and builds a VR store in a virtual space (Step S6). Then, the building unit 132 provides the VR store for the user terminals 20A and 20B (Steps S7-1 and S7-2). In addition, the building unit 132 may build a VR shopping mall in a virtual space and provide the VR shopping mall for the user terminals 20A and 20B.

In the server apparatus 10, when the reception unit 131 receives a request for sharing with the user B from the user A (Step S8), the sharing setting unit 133 inquires about sharing/no-sharing with the user A for the user terminal 20B of the user B (Step S9).

In the server apparatus 10, in a case in which sharing with the user A is permitted by the user terminal 20B (Step S10), the sharing setting unit 133 sets sharing between the user A and the user B (Step S11). The sharing setting unit 133 respectively displays avatars of the users A and B in the user terminals 20A and 20B and provides a chatting environment that can be shared between the users A and B for the user terminals 20A and 20B (Steps S12-1 and S12-2). For example, a comment is transmitted from the user A to the user B through chatting provided by the server apparatus 10 (Steps S13-1 and S13-2).

In the server apparatus 10, the sharing unit 134 estimates intention of the comment transmitted by the user A (Step S14) and judges whether or not the user A has intention for sharing a function of a virtual space with the user B (Step S15).

In a case in which it is judged that the user A have intention for sharing a function of a virtual space with the user B (Step S15: Yes), the sharing unit 134 inquires of the user terminal 20B about sharing/no-sharing of the function of the virtual space with the user A (for example, a display of the button C2 illustrated in FIG. 3) (Step S16). When the server apparatus 10 receives a request for sharing a function of a virtual space with the user A (for example, selection of the button C2 illustrated in FIG. 3) from the user terminal 20B (Step S17), the sharing unit 18 performs control such that the function of the virtual space is shared between the users A and B (Step S18 to Step S19-2).

### Effects of Embodiment

In the embodiment, a chatting environment that can be shared among a plurality of users is provided for each user terminal, and the function of the virtual space can be shared among the plurality of users through a chatting comment. In this way, in the embodiment, various functions of a virtual space can be easily shared among a plurality of users through chatting, and thus, also in the virtual space, a shopping environment among a plurality of persons that is of the same degree as that of an actual shop can be realized in a simple manner. In other words, in the embodiment, also in a VR store realized in a virtual space, similar to an actual shop, shopping can be performed together with friends and family members.

[System Configuration and the Like]

Each constituent element of each device that has been illustrated is functional and conceptual and does not need to be necessarily physically configured as illustrated in the drawings. In other words, a specific form of distribution/integration of each device is not limited to that illustrated in the drawing, and all or some thereof can be configured with being functionally or physically distributed/integrated in an arbitrary unit in accordance with various loads, a use status, and the like. In addition, the whole or an arbitrary part of each processing function performed in each device may be realized by a CPU and a GPU and programs that are interpreted and executed by the CPU or the GPU or may be realized by hardware according to wired logics.

Furthermore, among processes described in this embodiment, all or some of the processes described to be automatically performed may be manually performed, or all or some of the processes described to be manually performed may be automatically performed using a known method. Other than that, a processing sequence, a control sequence, a specific name, and information including various kinds of data and parameters illustrated in the specification or the drawings described above may be arbitrarily changed unless otherwise mentioned.

[Program]

In addition, a program in which the process performed by the server apparatus 10 described in the embodiment described above is described using a computer-executable language may be generated. For example, a program in which the process performed by the server apparatus 10 according to the embodiment is described using a computer-executable language may be generated as well. In such a case, by a computer executing the program, effects similar to those of the embodiment described above can be acquired. In addition, by recording such a program on a computer-readable recording medium and causing a computer to read and execute the program recorded on this recording medium, the process similar to that according to the embodiment described above may be realized.

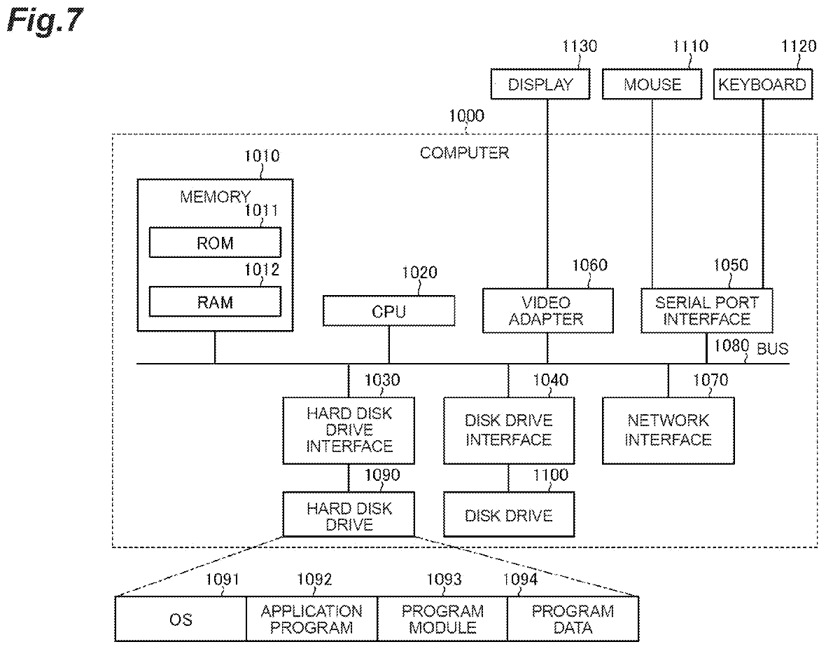

FIG. 7 is a diagram illustrating a computer executing a program. As illustrated in FIG. 7, for example, the computer 1000 includes a memory 1010, a CPU 1020, a hard disk drive interface 1030, a disk drive interface 1040, a serial port interface 1050, a video adaptor 1060, and a network interface 1070, and such units are connected through a bus 1080.

As illustrated in FIG. 7, the memory 1010 includes a read only memory (ROM) 1011 and a RAM 1012. For example, the ROM 1011 stores boot programs such as a Basic Input Output System (BIOS) and the like. As illustrated in FIG. 7, the hard disk drive interface 1030 is connected to a hard disk drive 1090. The disk drive interface 1040 is connected to a disk driver 1100. For example, a loadable/unloadable storage medium such as a magnetic disk, an optical disc, or the like is inserted into the disk driver 1100. For example, the serial port interface 1050 is connected to a mouse 1110 and a keyboard 1120. For example, the video adaptor 1060 is connected to a display 1130.

Here, as illustrated in FIG. 7, the hard disk drive 1090, for example, stores an OS 1091, an application program 1092, a program module 1093, and program data 1094. In other words, the program described above, for example, is stored in the hard disk drive 1090 as a program module in which instructions executed by the computer 1000 are described.

In addition, various kinds of data described in the embodiment described above, for example, is stored in the memory 1010 or the hard disk drive 1090 as program data. Then, the CPU 1020 reads the program module 1093 and the program data 1094 stored in the memory 1010 and the hard disk drive 1090 into the RAM 1012 as necessary and performs various processing sequences.

In addition, the program module 1093 and the program data 1094 relating to the program are not limited to being stored in the hard disk drive 1090 and, for example, may be stored in a loadable/unloadable storage medium and read by the CPU 1020 through a disk driver or the like. Alternatively, the program module 1093 and the program data 1094 relating to the program may be stored in another computer connected through a network (a local area network (LAN), a wide area network (WAN), or the like) and read by the CPU 1020 through the network interface 1070.

Like the embodiment described above and modifications thereof belong to the technology disclosed in the present application, they belong to the scope of inventions described in the claims and equivalency thereof.

### REFERENCE SIGNS LIST

10 Server apparatus
11 Communication unit
12 Storage unit
13 Control unit
20A, 20B User terminal
30 Shop server apparatus
121 Building information
122 User information
123 Shop and product information
131 Reception unit
132 Building unit
133 Sharing setting unit
134 Sharing unit

1. A processing device comprising processing circuitry configured to:
build a virtual shop at which viewing and purchase of a product can be performed by a user in a virtual space and provide the virtual shop for a user terminal used by the user;
provide, when entry of a plurality of users having a relationship into the virtual shop is registered, a chatting environment that can be shared among the plurality of users for the user terminal used by each of the plurality of users; and
perform control such that a function of the virtual space is shared among the plurality of users on the basis of a comment of a chatting.

2. The processing device according to claim 1, wherein the processing circuitry, in the virtual space, moves other users to a position of any one person among the plurality of users and shares positions among the plurality of users.

3. The processing device according to claim 1, wherein the processing circuitry, in the virtual space, shares information relating to a product being viewed by any one person among the plurality of users among the plurality of users.

4. The processing device according to claim 1, wherein the processing circuitry unit estimates whether or not a user who has written a comment of the chatting intends, in the contents of the comment, to share the function of the virtual space with other users, and in a case in which it is estimated that the user who has written the comment intends to share the function of the virtual space with other users, performs control such that the function of the virtual space is shared among the plurality of users.

5. The processing device according to claim 1, wherein the processing circuitry estimates whether or not a user who has written a comment of the chatting intends, in the contents of the comment, to share the function of the virtual space with other users, and, in a case in which it is estimated that the user who has written the comment intends to share the function of the virtual space with other users, represents a comment for inquiring about sharing/no-sharing in the chatting environment and, in a case in which the sharing is permitted, preforms control such that the function of the virtual space is shared among the plurality of users.

6. A processing method performed by a processing device, the processing method comprising:
a process of building a virtual shop at which viewing and purchase of a product can be performed by a user in a virtual space and providing the virtual shop for a user terminal used by the user;
a process of providing, when entry of a plurality of users having a relationship into the virtual shop is registered, a chatting environment that can be shared among the plurality of users for the user terminal used by each of the plurality of users; and
a process of performing control such that a function of the virtual space is shared among the plurality of users on the basis of a comment of a chatting.

7. A non-transitory computer readable storage medium storing a program causing a computer to execute steps of:
building a virtual shop at which viewing and purchase of a product can be performed by a user in a virtual space and providing the virtual shop for a user terminal used by the user;
providing, when entry of a plurality of users having a relationship into the virtual shop is registered, a chatting environment that can be shared among the plurality of users for the user terminal used by each of the plurality of users; and
performing control such that a function of the virtual space is shared among the plurality of users on the basis of a comment of a chatting.

8. The processing device according to claim 2, wherein the processing circuitry, in the virtual space, shares information relating to a product being viewed by any one person among the plurality of users among the plurality of users.
